(19) United States
(12) Patent Application Publication
(10) Pub. No.: US 2009/0137207 A1
(43) Pub. Date: May 28, 2009

(54) Wireless bell device and operating method thereof

(75) Inventor: Yao-Meng Peng, Taipei (TW)

Correspondence Address: REED SMITH LLP;Suite 1400, 3110 Fairview Park Drive, Falls Church, VA, 22042, US

(73) Assignee: Compal Communications, Inc.

(21) Appl. No.: 12/292,656

(22) Filed: Nov. 24, 2008

(30) Foreign Application Priority Data
Nov. 23, 2007 (TW) 096144395

(51) Int. Cl. H04B 7/00; G08B 3/00

(52) U.S. Cl. 455/41.3; 455/66.1; 340/328

(57) ABSTRACT

The invention provides a wireless bell device and an operating method thereof. The wireless bell device comprises a controlling module and a transmitting module. The controlling module has a button. When the button is pressed, a controlling signal is transmitted by the controlling module. The transmitting module is electrically connected to the controlling module. When the controlling signal is received by the transmitting module, the transmitting module transmits a wireless signal to a mobile communication device. The mobile communication device receives the wireless signal and rings a bell according to the wireless signal.

### BACKGROUND OF THE INVENTION

1. Field of the invention

The present invention relates generally to a bell, and more particularly, to a wireless bell device and an operating method thereof.

2. Description of the prior art

There are generally two kinds of bell receivers, mains-powered and battery powered. A mains-powered bell receiver is usually limited to be set at a fixed position; a battery powered bell receiver is portable, but users hardly ever take it with them. If a home is large, more bells need to be set to avoid not hearing the coming of guests'. However, the more set bells there are, the more inconvenient it is for users and also the cost is higher.

Accordingly, the main aspect of the present invention is to provide a wireless bell device and an operating method thereof to solve the problems mentioned above.

### SUMMARY OF THE INVENTION

According to an embodiment of the invention, the wireless bell device is fixed at a predetermined position and comprises a controlling module and a transmitting module. The controlling module has a button. When the button is pressed, the controlling module transmits a controlling signal. The transmitting module is electrically connected to the controlling module. When the transmitting module receives the controlling signal, the transmitting module transmits a wireless signal to a mobile communication device which receives the wireless signal and rings a bell according to the wireless signal.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 is a functional block illustrating a wireless bell device according to the first embodiment of the invention.

FIG. 2A and FIG. 2B illustrate respectively a beacon enabled data transmission mode and a non-beacon enabled data transmission mode.

FIG. 3 is a flow chart demonstrating a method of operating the wireless bell device according to the second embodiment of the invention.

### DETAILED DESCRIPTION OF THE INVENTION

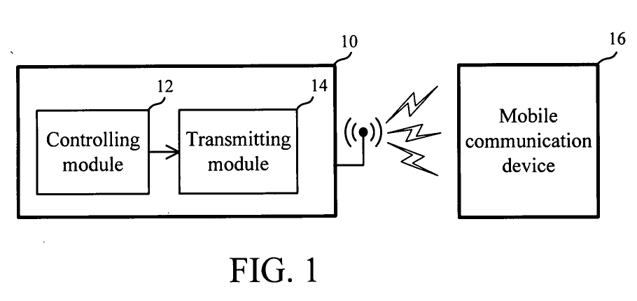

The first embodiment of the invention is a wireless bell device. Please refer to FIG. 1, FIG. 1 is a functional block illustrating a wireless bell device according to the first embodiment of the invention. The wireless bell device is fixed at a predetermined position. As illustrated in FIG. 1, the wireless bell device 10 comprises a controlling module 12 and a transmitting module 14. The controlling module 12 has a button. When the button is pressed, a controlling signal is transmitted by the controlling module 12. The transmitting module 14 is electrically connected to the controlling module 12. When the controlling signal is received by the transmitting module 14, the transmitting module 14 transmits a wireless signal to a mobile communication device 16. The mobile communication device 16 receives the wireless signal and rings a bell according to the wireless signal.

In practical application, the mobile communication device 16 could be a mobile phone. The bell could be a ring tone or a melodic member stored in the mobile communication device 16. The controlling module 12 can further comprise a voice/image sensor. When the voice/image sensor senses a voice and/or an image in a specific area at the predetermined position, the controlling module 12 then transmits the controlling signal, the voice and/or the image to the transmitting module 14.

The wireless bell device of the invention could adopt the ZigBee technique as a standard of communication with the transmitting module 14 and the mobile communication device 16. The said ZigBee technique is a fresh wireless transmission technique applied in a low speed and short distance of wireless transmission environment. The ZigBee technique started expanding in 1998, focusing on the developments of low electricity consumption, low cost, and induction type internet, etc, and was taken in IEEE 802.15.4 standard regulations in 2001. Since then, the ZigBee technique has gradually become one of the applicable short distance wireless communication techniques in the industry. Of course, the wireless bell device of the invention could also adopt other short distance communication techniques such as Bluetooth.

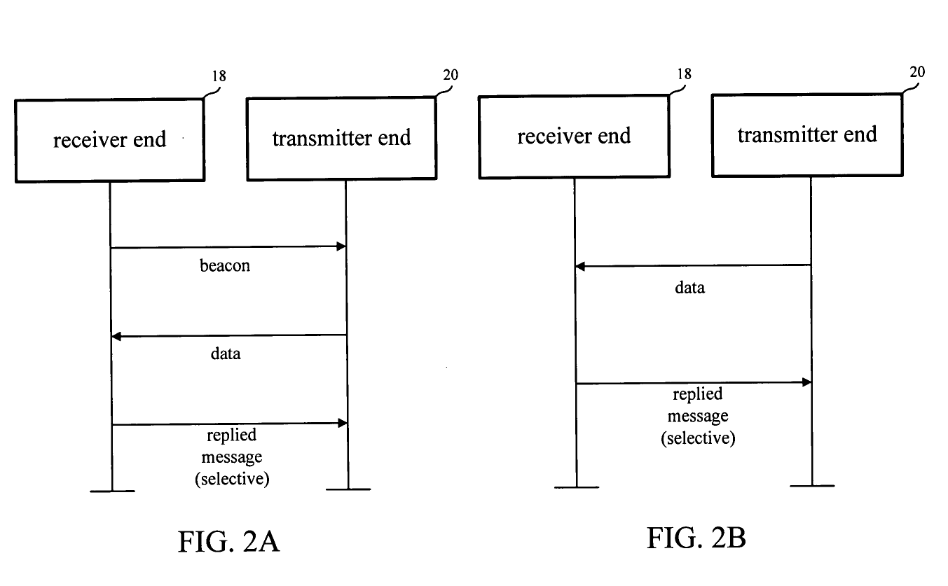

Regarding the data transmission modes between a transmitter end and a receiver end in the ZigBee technique, they are divided into two kinds of mode, beacon enabled mode and non-beacon enabled mode, according mainly to if the receiver end actively transmits a beacon to the transmitter end. FIG. 2A and FIG. 2B illustrate respectively a beacon enabled data transmission mode and a non-beacon enabled data transmission mode.

As illustrated in FIG. 2A, in beacon enabled mode, the receiver actively transmits a beacon to the transmitter to let the transmitter detect the existence of the receiver in its capable transmitting area. When the button of the transmitter is pressed, the data is transmitted by the transmitter to the receiver. After receiving the data, the receiver could selectively transmit a reply message to the transmitter to let the transmitter realize that the receiver has received the data. If the transmitter doesn't receive the reply message, it can actively transmit the data to the receiver again. However if the transmitter can not detect the existence of the receiver in its capable transmitting area, it stops transmitting data.

Operation in non-beacon enabled mode is simpler. As illustrated in FIG. 2B, no matter if the receiver exists or not in the transmitter's capable transmitting area, when the button of the transmitter is pressed, the transmitter transmits the data to the receiver and waits for a reply message selectively replied by the receiver. If the transmitter doesn't receive the reply message, it can actively transmit the data to the receiver again.

Furthermore, when the transmitting module 14 receives the controlling signal, the transmitting module 14 could transmit the wireless signal to a buzzer. The buzzer could buzz according to the wireless signal. Combining the mobile communication device 16 with the buzzer, the wireless device of the invention can effectively extend the capable range of receiving bell messages. In practical application, the wireless device 10 could comprise of plural mobile communication devices 16 and plural buzzers.

In the wireless bell device 10, each of the transmitting module 14, the mobile communication device 16 and the buzzer has a built-in full function device (FFD) ZigBee chip respectively, and thereby transmits the wireless signal by ZigBee short distance wireless communication technique. Moreover, the mobile communication device 16 could further comprise a display module (not shown in the FIG.). The display module is for revealing information according to the wireless signal, and the information is corresponding to the transmitting module 14.

For example, if the mobile communication device is a mobile phone, when the button of the wireless bell device is pressed or the voice/image sensor senses a voice and/or an image in a specific area, then the controlling module transmits a controlling signal to the transmitting module. When the controlling signal is received by the transmitting module, the transmitting module transmits a wireless signal. At this time, the mobile phone plays a role of a wireless signal receiver, receives the wireless signal and rings a bell according to the wireless signal. When users hear the bell, they can realize that someone is visiting or calling. Corresponding to different transmitting modules, the information revealed on the display module of the mobile phone differs. Therefore, users could judge immediately if the wireless signal is transmitted from which transmitting module according to the information revealed on the mobile phone screen. Additionally, the wireless bell device 10 could also set different ring tones of the mobile phone corresponding to different transmitted modules. So that users can recognize the directions from the voices. Namely, users can know the bell transmitting module in which direction is touched according to different ring tones.

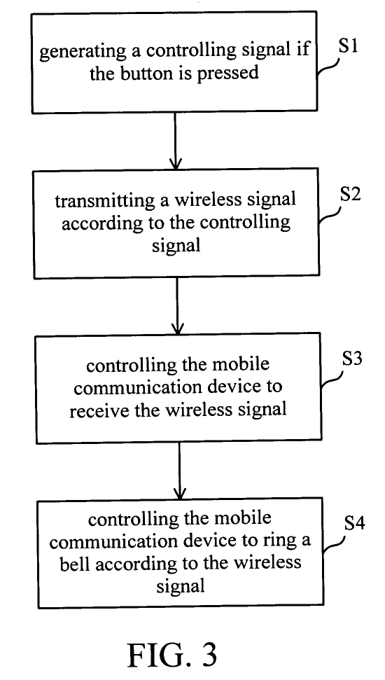

The second embodiment of the invention is a method of operating a wireless bell device. The wireless bell device is fixed in a predetermined position and communicates wirelessly with a mobile communication device. Please refer to FIG. 3, FIG. 3 is a flow chart demonstrating the method of operating the wireless bell device. Firstly, step S1 is performed according to the embodiment to provide a button and generate a controlling signal if the button is pressed. Secondly, step S2 is performed in the embodiment to transmit a wireless signal according to the controlling signal. Subsequently, step S3 is performed in the embodiment to control the mobile communication device to receive the wireless signal. Finally, step S4 is performed in the embodiment to control the mobile communication device to ring a bell according to the wireless signal.

In practical application, if the wireless bell device further comprises a voice/image sensor, and when the voice/image sensor senses a voice and/or an image in a specific area, the method could further control the mobile communication device to receive the voice and/or the image. Then, the method could control the mobile communication device to reveal the voice and/or the image.

If the wireless bell device communicates wirelessly with a buzzer, the method could also control the buzzer to receive the wireless signal and control the buzzer to buzz according to the wireless signal. Furthermore, the method could control the mobile communication device to reveal information according to the wireless signal wherein the information is corresponding to the transmitting module. In the method of operating the wireless bell device, each of the wireless bell device, the mobile communication device and the buzzer has a built-in full function device (FFD) ZigBee chip respectively.

Compared to prior art, the wireless bell device and the operating method thereof of the invention could enable users to use only the mobile communication device with them to know the bell messages immediately. It solves not only the disadvantage that the mains-powered bell receiver is usually limited to be set at a fixed position, but also the problem that battery powered bell receiver is portable, but users hardly ever take it with them. According to the wireless bell device, it is not necessary to set excess bells to avoid not hearing the coming of guests'.

Although the present invention has been illustrated and described with reference to the preferred embodiment thereof, it should be understood that it is in no way limited to the details of such embodiment but is capable of numerous modifications within the scope of the appended claims.

What is claimed is:

1. A wireless bell device fixed in a predetermined position comprising:
a controlling module having a button, wherein when the button is pressed, the controlling module transmits a controlling signal; and
a transmitting module electrically connected to the controlling module, wherein when the transmitting module receives the controlling signal, the transmitting module transmits a wireless signal to a mobile communication device which receives the wireless signal and rings a bell according to the wireless signal.

2. The wireless bell device of claim 1, wherein the controlling module further comprises a voice/image sensor, and when the voice/image sensor senses a voice and/or an image in a specific area at the predetermined position, the controlling module transmits the controlling signal, the voice and/or the image to the transmitting module.

3. The wireless bell device of claim 1, wherein when the transmitting module receives the controlling signal, the transmitting module transmits the wireless signal to a buzzer.

4. The wireless bell device of claim 3, wherein each of the transmitting modules, the mobile communication device and the buzzer has a built-in full function device (FFD) ZigBee chip respectively.

5. The wireless bell device of claim 1, wherein the mobile communication device is a mobile phone.

6. The wireless bell device of claim 1, wherein the bell is a ring tone or a piece of music stored in the mobile communication device.

7. The wireless bell device of claim 1, wherein the mobile communication device further comprises:
a display module for revealing any information according to the wireless signal, and the information is corresponding to the transmitting module.

8. A method of operating a wireless bell device fixed in a predetermined position and communicating wirelessly with a mobile communication device, the method comprising the following steps:
providing a button and generating a controlling signal if the button is pressed;
transmitting a wireless signal according to the controlling signal;
controlling the mobile communication device to receive the wireless signal; and
controlling the mobile communication device to ring a bell according to the wireless signal.

9. The method of claim 8, wherein the wireless bell device further comprises a voice/image sensor, and when the voice/image sensor senses a voice and/or an image in a specific area at the predetermined position, the method further comprising the following steps:
controlling the mobile communication device to receive the voice and/or the image; and
controlling the mobile communication device to reveal the voice and/or the image.

10. The method of claim 8 further comprising the following step:
controlling the mobile communication device to reveal any information which is corresponding to the transmitting module.

11. The method of claim 8, wherein the wireless bell device communicates wirelessly with a buzzer, the method further comprising the following steps:
controlling the buzzer to receive the wireless signal; and
controlling the buzzer to buzz according to the wireless signal.

12. The method of claim 11, wherein each of the wireless bell device, the mobile communication device and the buzzer has a built-in full function device (FFD) ZigBee chip respectively.

13. The method of claim 8, wherein the mobile communication device is a mobile phone.

14. The method of claim 8, wherein the bell is a ring tone or a piece of music stored in the mobile communication device.
